(19) United States
(12) Patent Application Publication
(10) Pub. No.: US 2013/0127280 A1
(43) Pub. Date: May 23, 2013

(54) ELECTRIC ROTATING MACHINE AND ELECTRIC VEHICLE USING THE SAME

(71) Applicants: Shinji Sugimoto, Hitachinaka (JP); Akiyoshi Komura, Hitachi (JP); Shigeru Kakugawa, Hitachi (JP); Satoshi Kikuchi, Tokai (JP)

(72) Inventors: Shinji Sugimoto, Hitachinaka (JP); Akiyoshi Komura, Hitachi (JP); Shigeru Kakugawa, Hitachi (JP); Satoshi Kikuchi, Tokai (JP)

(73) Assignee: Hitachi, Ltd.

(21) Appl. No.: 13/812,736

(22) PCT Filed: Jul. 30, 2010
(86) PCT No.: PCT/JP2010/004844

§ 371 Date: Jan. 28, 2013

(51) Int. Cl. H02K 1/02

(52) U.S. Cl. CPC H02K 1/02
USPC 310/156.01

(57) ABSTRACT

An electric rotating machine that can improve efficiency in the high-speed operation state thereof and improve the efficiency of an electric vehicle in the high-speed operation state thereof by the use of the electric rotating machine. An electric rotating machine includes a stator and a rotor. The stator has a stator core with slots and stator windings. The rotor includes a rotor core and a plurality of first permanent magnets and of second permanent magnets. The rotor core is provided with laminated electromagnetic steel sheets and formed with a plurality of magnetic poles arranged in a circumferential direction. The plurality of first and second permanent magnets form the plurality of corresponding magnetic poles. The first permanent magnet and the second permanent magnet for forming each of the magnetic poles of the rotor are different from each other in recoil permeability.

### TECHNICAL FIELD

The present invention relates to an electric rotating machine and an electric vehicle using the electric rotating machine.

### BACKGROUND ART

Some electric rotating machines are such that magnetic poles of a rotor are formed by permanent magnets. In these electric rotating machines, the magnetic flux of a d-axis generated by the permanent magnets is constant. Therefore, substantially constant magnetic flux intersects the stator windings regardless of rotational speed. Thus, the back-EMF induced in a stator is increased as rotational speed increases. On the other hand, the voltage of a power source to supply an AC current to the stator windings is substantially constant regardless of the rotational speed of the electric rotating machine. Thus, if the rotational speed of the electric rotating machine is increased to increase the back-EMF induced in the stator windings as described above, a difference in voltage between the power voltage and the interphase voltage of the stator windings is reduced, so that it becomes impossible to supply the current required for the stator windings. Consequently, if the electric rotating machine is increased in rotational speed, it becomes difficult for required rotary torque to be generated.

The back-EMF along with the increased rotational speed of the electric rotating machine is suppressed to a low level as much as possible. This makes it easy to supply the required current to the stator windings. Thus, torque generated during high-speed rotation can be more increased. One of solutions to suppress the back-EMF to a low level as much as possible is to reduce the magnetic flux of the d-axis intersecting the stator windings. The amount of the magnetic flux of the d-axis intersecting the stator windings is suppressed, the magnetic flux of the d-axis being generated by the permanent magnets forming the magnetic pole during the high-speed operation of the electric rotating machine. For this purpose, a current supplied to the stator windings is controlled to generate in the stator windings the magnetic flux with a polarity opposite to that of the magnetic flux of the d-axis generated by the permanent magnets (the field weakening control).

Patent Document 1 discloses the technology in which the magnetic flux of a d-axis is irreversibly demagnetized by field weakening control to reduce the linkage magnetic flux of stator windings.

If a large field weakening current is used, the current of a d-axis unrelated directly to the rotary torque of a motor is increased, which lowers efficiency. Thus, there is a problem with the lowered efficiency of the electric rotating machine in a high-speed operation state.

### PRIOR ART DOCUMENT

### Patent Document

Patent Document 1: JP-2008-245367-A

### SUMMARY OF THE INVENTION

### Problem to be Solved by the Invention

It is an object of the present invention to provide an electric rotating machine that can improve its efficiency in a high-speed operation state. In addition, it is another object of the invention to improve the efficiency of an electric vehicle in a high-speed operation state by the use of the electric rotating machine of the present invention.

### Means for Solving the Problem

The characteristic recited in claim 1 is as below.

An electric rotating machine includes a stator and a rotor. The stator has a stator core with slots and stator windings. The rotor includes a rotor core and a plurality of first permanent magnets and of second permanent magnets. The rotor core is provided with laminated electromagnetic steel sheets and formed with a plurality of magnetic poles arranged in a circumferential direction. The plurality of first and second permanent magnets form the plurality of corresponding magnetic poles. The first permanent magnet and the second permanent magnet for forming each of the magnetic poles of the rotor are different from each other in recoil permeability.

The characteristic recited in claim 2 is that in the configuration recited in the above claim 1, the second permanent magnet is disposed so that a magnetization easy axis of the second permanent magnet forming each magnetic pole of the rotor is disposed along magnetic flux of a d-axis made by the first permanent magnet.

The characteristic recited in claim 3 is as below. In the electric rotating machine recited in claim 1 or 2, the rotor core of the electric rotating machine is formed with a magnetic insertion hole adapted to receive permanent magnets for forming each magnetic pole, and the first permanent magnet and the second permanent magnet are received and held in the magnet insertion hole.

The characteristic recited in claim 4 is as below. In the electric rotating machine recited in any one of claims 1 to 3, the first permanent magnet has a coercivity property higher than that of the second permanent magnet, and the second permanent magnet has recoil permeability higher than that of the first permanent magnet.

The characteristic recited in claim 5 is as below. In the electric rotating machine recited in claim 4, the first permanent magnet is a neodymium magnet or a ferrite magnet and the second permanent magnet is an AlNiCo magnet.

The characteristic recited in claim 6 is as below. In the electric rotating machine recited in any one of claims 1 to 3, the rotor has auxiliary magnetic poles each formed between magnetic poles adjacent to each other among a plurality of magnetic poles formed along the circumferential direction, and a magnetic circuit is formed through which magnetic flux of a q-axis generated by the stator windings passes via the auxiliary magnetic pole.

The characteristic recited in claim 7 is as below. In the electric rotating machine recited in claim 6, the rotor has the magnet insertion holes formed along the circumferential direction so as to correspond to the associate magnetic poles. The magnet insertion holes are each adapted to receive the first permanent magnet and the second permanent magnet forming a corresponding one of the magnetic poles arranged in the circumferential direction. The magnet insertion hole is shaped to have a circumferential length greater than a radial length. The magnetic insertion hole is shaped such that a side located on the outer circumferential side of the rotor has a length greater than a side located on a central side of the rotor. The first permanent magnet and the second permanent magnet are fixedly received in each of the magnet insertion holes in a laminated state in a radial direction of the rotor. The first permanent magnet and the second permanent magnet are magnetized along the radial direction of the rotor in such a manner as to have respective magnetic polarities alternately reversed for each magnetic pole. Magnetic air gaps are provided inside each of the magnet insertion holes at both circumferential ends of at least a permanent magnet located on an outer circumferential side of the first and second permanent magnets.

The characteristic recited in claim 8 is as below. In the electric rotating machine recited in claim 7, a magnetic pole piece portion is formed in the rotor core between the outer circumferential side of the magnet insertion hole for each magnetic pole and the outer circumference of the rotor core, and a magnetic circuit is formed in which the magnetic flux of the d-axis generated by the first and second permanent magnets passes through the magnetic pole piece portion and the stator core and intersects the stator windings.

The characteristic recited in claim 9 is as below. In the electric rotating machine recited in claim 6, at least two sets of the first permanent magnets and the second permanent magnets for forming each magnetic pole are installed in the rotor so as to correspond to each of the magnetic poles arranged in the circumferential direction, and a first magnet insertion hole adapted to receive one set of the first and second permanent magnets of the two sets and a second magnet insertion hole adapted to receive the other set of the first and second permanent magnets are formed so as to correspond to each of the magnetic poles. The first magnet insertion hole and the second magnet insertion hole provided so as to correspond to each of the magnetic poles are formed in a state where an outer circumferential side thereof is more open than a central side thereof, i.e., where ends of the first and second magnet insertion holes on the outer circumferential side of the rotor are more spaced from each other than ends thereof on the central side of the rotor. The first permanent magnet and the second permanent magnet are fixedly received in each of the first magnet insertion hole and the second magnet insertion hole in a stacked state.

The characteristic recited in claim 10 is as below. In the electric rotating machine recited in claim 9, a magnetic air gap is formed at the outer circumferential-side end portion of each of the first magnet insertion hole and the second magnet insertion hole.

The characteristic recited in claim 11 is as below. In the electric rotating machine recited in claim 10, a magnetic pole piece portion is formed in the stator core on the outer circumferential side of the first magnet insertion hole and the second magnet insertion hole, and a magnetic circuit is formed in which the magnetic flux of the d-axis generated by the first and second permanent magnets passes through the magnetic pole piece portion and the stator core and intersects the stator windings.

The characteristic recited in claim 12 is as below. In the electric rotating machine recited in any one of claims 8 to 11, an auxiliary magnetic pole is formed between the magnetic poles adjacent to each other, and a bridge portion connecting the magnetic pole piece portion with the auxiliary magnetic pole portion adjacent thereto is formed on the outer circumferential side of the magnetic air gap, the bridge portion reducing leakage magnetic flux from the magnetic piece portion to the auxiliary magnetic pole.

The characteristic recited in claim 13 is as below. In an electric vehicle including the electric rotating machine recited in any one of claims 1 to 12, the electric vehicle includes a control circuit for controlling the electric rotating machine and the control circuit operates the first and second permanent magnets within a range of reversible demagnetization.

The characteristic recited in claim 14 is as below. In the electric vehicle recited in claim 13, in a first operating range where rotational speed of the electric rotating machine is higher than a predetermined rotational speed, the control circuit controls an AC current to be supplied to the stator windings so as to generate magnetic flux in a direction of reducing magnetic flux of a d-axis generated by the permanent magnets, and the magnetic flux generated by the stator windings acts as magnetic flux with a polarity opposite to that of the second permanent magnet forming the magnetic pole of the rotor.

### EFFECT OF THE INVENTION

The present invention has an effect of enabling an improvement in the efficiency of the electric rotating machine in the high-speed operating state. The electric vehicle including the electric rotating machine can improve the efficiency thereof in the high-speed operating state.

### BRIEF DESCRIPTION OF THE DRAWINGS

FIG. 1 is a partial cross-sectional view of an electric rotating machine according to a first embodiment of the present invention.

FIG. 2 is a cross-sectional view taken along a plane vertical to a rotational axis of the electric rotating machine illustrated in FIG. 1.

FIG. 3 is a partial enlarged view of FIG. 2.

FIG. 4 is a magnetic signature of a permanent magnet with high recoil permeability.

FIG. 5 is a magnetic signature of a permanent magnet with low recoil permeability.

FIG. 6 is a diagram for assistance in explaining the relationship between an operating point and an angular difference in magnetization easy axis direction between permanent magnets with high recoil permeability and with low recoil permeability.

FIG. 7 is a system diagram of a system for driving the rotating electric machine.

FIG. 8 is an explanatory diagram showing the relationship between the phase of current and torque of the electric rotating machine using permanent magnets.

FIG. 9 is a cross-sectional view of a rotor according to a second embodiment of the present invention.

FIG. 10 is a cross-sectional view of a rotor according to a third embodiment of the present invention.

FIG. 11 is a cross-sectional view of a rotor according to a fourth embodiment of the present invention.

FIG. 12 is a cross-sectional view of a rotor according to a fifth embodiment of the present invention.

FIG. 13 is a cross-sectional view of a rotor according to a sixth embodiment of the present invention.

FIG. 14 is a cross-sectional view of a rotor according to a seventh embodiment of the present invention.

FIG. 15 is a cross-sectional view of a rotor according to an eighth embodiment of the present invention.

FIG. 16 is a cross-sectional view of a rotor according to a ninth embodiment of the present invention.

FIG. 17 is a block diagram of an electric vehicle according to a tenth embodiment to which the present invention is applied.

### MODE FOR CARRYING OUT THE INVENTION

Embodiments describe below not only the contents in the columns of the above “Problem to be Solved by the Invention” and “Effect of the Invention” but also solutions to various problems to put productions to practical use. Their specific details will be described in the following embodiments.

### Embodiment 1

### Permanent Magnets Arranged in a V-Shape

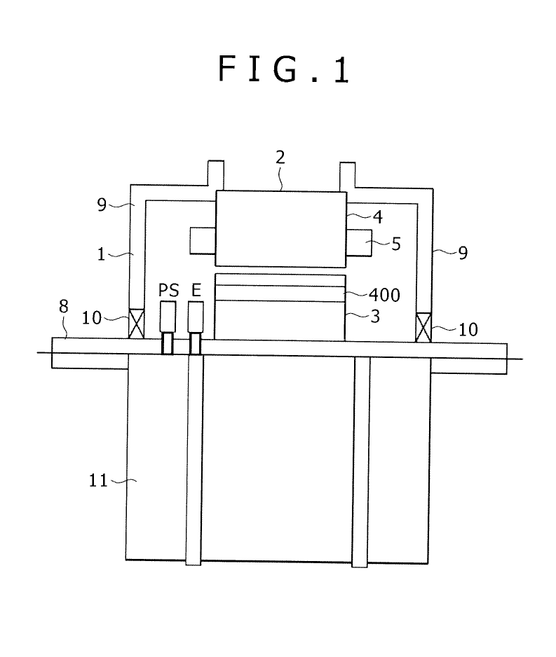

A first embodiment of the present invention will be described with reference to FIGS. 1 to 8. FIG. 1 is a partial cross-sectional view of an electric rotating machine 1 using permanent magnets according to the present embodiment of the invention. A stator 2 of the electric rotating machine 1 using permanent magnets includes a stator core 4 and three-phase or multiphase stator windings 5 wound around slots formed on the stator core 4. The stator 2 is housed in and held by a housing 11. The rotor 3 includes a rotor core 7 provided with magnet insertion holes 6 adapted to receive permanent magnets inserted thereinto, permanent magnets 400 inserted into the magnet insertion holes 6 formed in the rotor core 7 so as to form the magnet poles of the rotor, and a shaft 8. The shaft 8 is rotatably held via bearings 10 by end brackets 9 secured to both ends of the housing 11.

The electric rotating machine 1 has a magnetic pole position detector PS for detecting the position of the magnetic pole of the rotor 3. The magnetic pole position detector PS is composed of e.g. a resolver. Further, the electric rotating machine 1 has a rotational speed detector E for detecting the rotational speed of the rotor 3. In this embodiment, the rotational speed detector E is an encoder. The encoder is disposed on the side of the rotor 3 and produces pulses in synchronization with the rotation of the shaft 8. The encoder can determine the rotational speed by counting the number of the pulses. The electric rotating machine 1 detects the position of the magnet on the basis of the signal of the magnetic pole detector PS and the rotational speed on the basis of the output signal of the rotational speed detector E. A control unit, not shown, supplies to the stator windings 5 an alternating current for generating the target torque of the electric rotating machine 1. In this way, the current to be supplied to the stator windings 5 is controlled by the control unit, thereby controlling the output torque of the electric rotating machine.

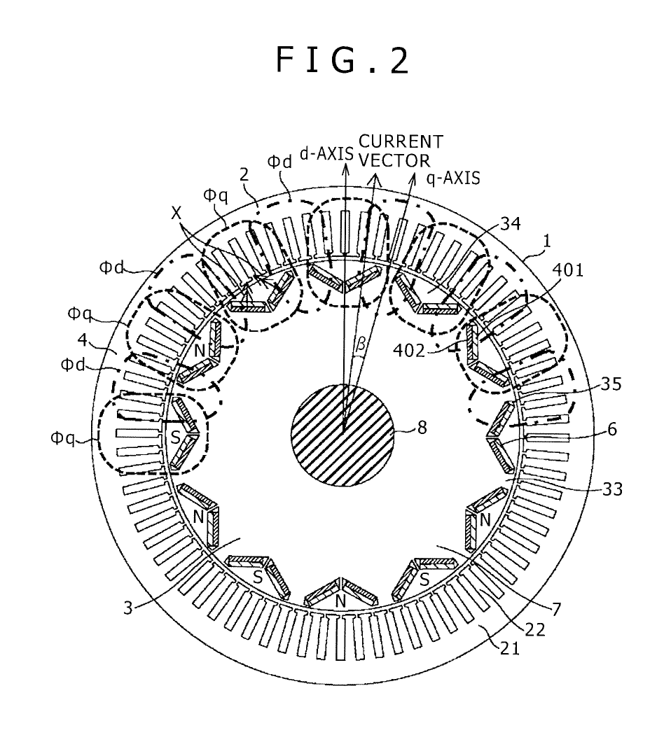

The permanent magnets 400 include first permanent magnets 401 (shown in FIG. 2) such as neodymium magnets, ferrite magnets or the like with the property of low recoil permeability and second permanent magnets 402 (shown in FIG. 2) such as AlNiCo magnets with the property of high recoil permeability. As described above, the first and second permanent magnets forming magnet poles are composed of at least two types of permanent magnets different in recoil permeability from each other. As described above, the first permanent magnet 401 with low recoil permeability is a neodymium magnet or a ferrite magnet. The neodymium magnet has a recoil permeability of 1.05. The ferrite magnet has a recoil permeability of 1.15. The second permanent magnet 402 with high recoil permeability is e.g. an AlNiCo magnet. The AlNiCo magnet has a recoil permeability of 3.6. As regards the coercivity of magnets, the neodymium magnet or the ferrite magnet, which are the first permanent magnet, has coercivity greater than that of the AlNiCo magnet. The coercivity is defined as a magnetic field in an opposite direction required reducing the magnetic flux density generated by a permanent magnet to zero. In this case, the coercivity of the neodymium magnet is 836 to 995 kA/m. The coercivity of the ferrite magnet is 239 to 270 kA/m. The coercivity of the AlNiCo magnet is 47.7 to 52.5 kA/m. Incidentally, A/m mentioned above stands for ampere per meter, which is a unit of the strength of a magnetic field.

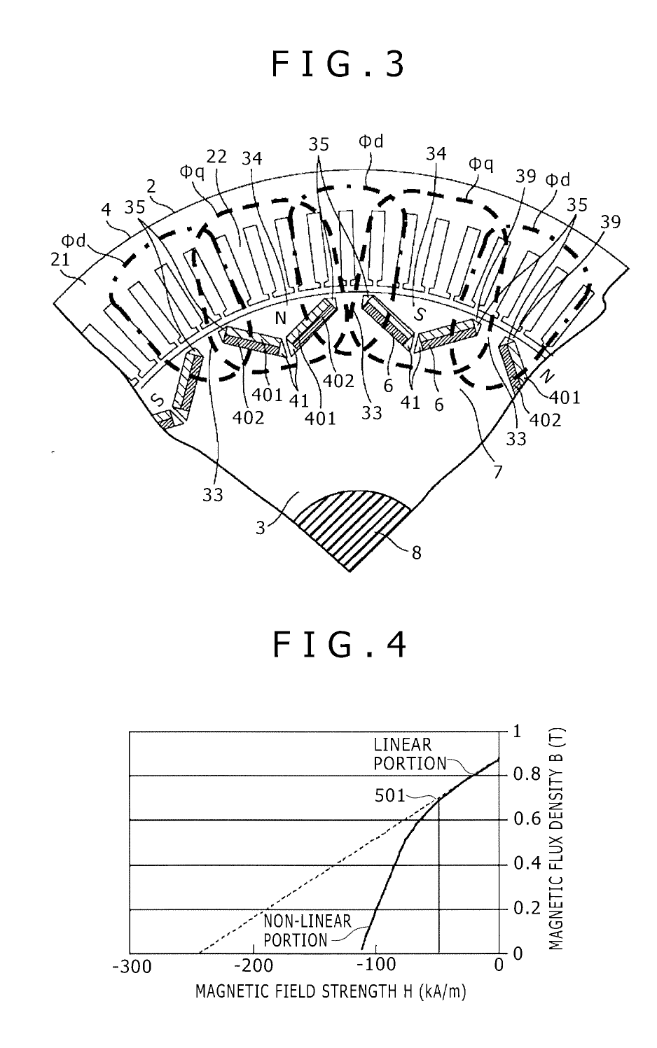

FIG. 2 is a cross-sectional view taken along a plane vertical to the rotational axis of the rotating electric machine shown in FIG. 1. Incidentally, the illustration of the housing is omitted to avoid complications. FIG. 3 is a partial enlarged view of FIG. 2. In these figures, the electric rotating machine 1 has the stator 2 and the rotor 3. The stator 2 has the stator core 4 and the stator windings 5 wound around slots which are formed on the rotor side of the stator core 4 and over the whole circumference in the circumferential direction. Incidentally, to avoid complications, FIGS. 2 and 3 omit the illustration of the stator windings. The stator core 4 has a generally cylindrical yoke portion 21, also called a core back portion, and teeth portions 22 shaped to project radially inward from the yoke portion 21. The teeth portions 22 are formed over the whole circumference. The slot is defined between the teeth portions 22 adjacent to each other. The slots receive and hold the stator windings. A three-phase alternating current is supplied to the stator windings arranged over the whole circumference to generate rotating magnetic fields in the stator. The magnetic flux generated by the rotor described later intersects the stator windings to rotate the rotor, so that the interlinkage flux is changed, which generates induced voltage in the stator windings.

The rotor 3 includes the rotor core 7 composed of electromagnetic steel sheets laminated in the direction along the rotational axis, and the first permanent magnets 401 and the second permanent magnets 402 installed in the rotor core 7 to form magnetic poles. In the embodiment with FIGS. 2 and 3, magnets disposed in a V-shape form a single magnetic pole, i.e., each magnetic pole. The magnets forming the magnetic pole are each magnetized in the radial direction. If one magnet is magnetized to form an N pole on the stator side, magnets forming magnetic poles on either side of the magnet are oppositely magnetized to form a S pole on the stator side. That is to say, the magnetizing direction of the first permanent magnet 401 and the second permanent magnet 402 forming the magnetic pole is reversed for each magnetic pole. Incidentally, each magnetic pole is formed by at least two sets of magnets arranged in the V-shape as described above in the first embodiment. However, the magnets forming each magnetic pole are not limited to the V-shaped arrangement. They may be arranged in a rectangle or in a shape combining a V-shape with a rectangle. If the amount of material for the magnets forming each magnetic pole is increased, the magnetic flux content of each magnetic pole is increased. Thus, generated rotary torque or induced back-EMF tends to increase.

In FIGS. 1 to 3, if reference numerals are attached to all appropriate parts or portions, the figures are very complicated. Therefore, the reference numerals are attached to a portion of the same parts as the representative thereof and reference numerals for the other parts are omitted. The technical concept of the present invention can be applied also to a rotating electric machine having the configuration in which permanent magnets forming magnetic poles are arranged on the outer circumferential surface, i.e., on the stator side, of a rotor core (hereinafter, also referred to as the surface permanent magnet type electric rotating machine). However, the electric rotating machine shown in the embodiment of the present application has the configuration in which the magnets are arranged inside the rotor core (referred to as the interior permanent magnet type electric rotating machine). The surface permanent magnet type electric rotating machine has a remarkable effect of suppressing variations in generated rotary torque; however, it has the drawback of lowering efficiency. The surface permanent magnet type electric rotating machine is suitable for a motor that assists steering force essential to suppress variations in rotary torque. On the other hand, the interior permanent magnet type electric rotating machine can reduce the gap between the rotor and the stator; therefore, it is suitable for high-efficiency, small-sized and high-power electric rotating machines, that is, for electric rotating machines for driving automobiles. All the embodiments of the present application are suitable for the electric rotating machine for driving automobiles.

In the embodiment illustrated in FIGS. 2 and 3, two sets of magnet insertion holes 6 adapted to insert and secure permanent magnets into and to the rotor core 7 are provided to correspond to each magnet pole. The two sets of magnet insertion holes 6 provided to correspond to each magnet pole is arranged to be open toward the stator. The two sets of magnet insertion holes 6 are arranged over the whole circumference to correspond to each of the magnet poles.

The first permanent magnet 401 with low recoil permeability and the second permanent magnet 402 with high recoil permeability are received and secured in each of the magnet insertion holes 6 in such a laminated state as to have the same magnetizing direction and polarities in the same direction with each other. In addition, they are magnetized to have polarities opposite to those of the first permanent magnet 401 and the second permanent magnet 402 that form an adjacent magnet pole as described above.

The magnet insertion holes 6 of the rotor core 7 are each formed by punching using a press machine, for example. The rotor core 7 formed of the electromagnetic steel sheets laminated in the direction along the rotational axis is secured to the shaft 8 for rotation therewith.

The rotor core 7 of the rotor 3 forms, over the whole circumference, auxiliary magnetic pole portions 33 each of which is located between magnetic poles adjacent each other in the circumferential direction. The auxiliary magnetic pole portion 33 is adapted to pass therethrough magnetic flux φq of a q-axis generated by the stator. The rotor core 7 of the rotor 3 is partially illustrated in FIG. 3. If the opposite view is taken, the magnetic pole formed by the permanent magnets is located between the auxiliary magnetic pole portions 33 adjacent to each other. In the present embodiment, each magnetic pole is configured such that the two sets of permanent magnets are arranged in such a V-shape as to be opened toward the stator. A first permanent magnet and a second permanent magnet received and held in each of the magnet insertion holes are the first permanent magnet 401 with low recoil permeability and the second permanent magnet 402 with high recoil permeability, respectively. Permanent magnets that forms each set of the two sets of permanent magnets forming the magnetic pole are composed of at least two types of permanent magnets different from each other in recoil permeability. For example, the first permanent magnet 401 with low recoil permeability is a neodymium magnet or a ferrite magnet. The second permanent magnet 402 with high recoil permeability is an AlNiCo magnet. The two sets of the first permanent magnets 401 and second permanent magnets 402 arranged in the above V-shape generate the magnetic flux φd of a d-axis and form the magnetic circuit as below. The magnet flux φd of the d-axis starts from the first permanent magnet 401 and the second permanent magnet 402, via the magnetic pole piece portion 34 and via the gap between the rotor 3 and the stator 4, passes through the stator 2, the first permanent magnet 401 and the second permanent magnet 402 which form another adjacent electric pole, and returns to the original first permanent magnet 401 and second permanent magnet 402. The magnetic pole piece portion 34 is formed by the rotor core 7 between the first permanent magnet 401 and the second permanent magnet 402, and the outer circumference of the rotor. When passing through the stator 2, the magnetic flux φd that passes through the magnetic circuit acts on a current flowing through the stator windings 5 to generate rotary torque. The magnetic flux φd that passes through the magnetic circuit intersects the stator windings 5 (see FIG. 1), and back-EMF is generated on the basis of a variation per unit time in the interlinkage flux. Although the magnetic flux φd is not always accurately depicted in the magnetic flux distribution diagrams of FIGS. 2 and 3, the magnetic flux φd flows along the magnetization direction inside the first permanent magnet 401 and the second permanent magnet 402 and vertically enters or leaves the surfaces thereof. In addition, the magnetic flux φd vertically enters or leaves the surfaces of the stator core 4 and the rotor cover 7.

Reluctance torque is generated based on a difference between the magnetic resistance of the magnetic flux φd of the q-axis passing through the auxiliary magnetic pole portion 33 and the magnetic resistance of the magnetic circuit having the permanent magnets through which the magnetic flux φd of the d-axis passes. The circumferential width of the auxiliary magnetic pole portion 33 is made wide in the present embodiment as illustrated in FIG. 3; therefore, the magnetic resistance of the magnetic circuit of the magnetic flux φd passing through the auxiliary magnetic pole portion 33 is small. On the other hand, the magnetic circuit through which the magnetic flux φd passes has the two sets of permanent magnets with low permeability; therefore, magnetic resistance is extremely high. Thus, large reluctance torque is generated in the present embodiment. The entire torque required for the electric rotating machine is equal to a total of the magnet torque and the reluctance torque. Therefore, if the reluctance torque is largely generated, the required magnet torque may be small accordingly. The electric rotating machine shown in FIGS. 2 and 3 has reluctance torque that accounts for some of the torque developed thereby. For example, the reluctance torque covers approximately half the required magnet torque. Therefore, the required magnet torque can be reduced, so that the electric generating machine is configured to enable a reduction in the amount of material for the permanent magnets. The reduction in the amount of the permanent magnet material can reduce the amount of magnetic flux intersecting the stator windings 5. Thus, an increase in back-EMF due to an increase in rotating speed can be suppressed. Thus, the electric rotating machine of the present embodiment has a configuration suitable for an electric rotating machine that rotates at high speed. In addition to this point, the present embodiment has the permanent magnets with high recoil permeability; therefore, it is further easy to reduce back-EMF during high-speed rotation as described below.

In FIGS. 2 and 3, the two sets of magnet insertion holes 6 arranged in the V-shape are formed in the rotor core 4. In addition, the two types of the first permanent magnet 401 and the second permanent magnet 402 different from each other in recoil permeability are inserted in each of the magnet insertion holes 6. The magnet insertion hole 6 has a shape greater than that of the two types of the first permanent magnet 401 and the second permanent magnet 402. A magnetic air gap 35 is formed at a stator-side end portion of the first permanent magnet 401 and the second permanent magnet 402. The magnetic air gap 35 is provided at an end portion of the permanent magnet located at least on the side of the magnetic pole piece portion 34. The magnetic air gap 35 is a space having a property similar to a vacuum or air with extremely high magnetic resistance. In addition, the magnetic air gap 35 is a space in an air gap state or filled with resin or the like, namely, a space where a paramagnetic substance or a ferromagnetic substance does not exist. In the following description, also other magnetic air gaps exist and they have the same structure as that of the magnetic air gap 35. Since the magnet insertion hole 6 has the shape greater than that of the magnets inserted thereinto, a magnetic air gap 41 is formed also at the rotational axis-side end portion of the first permanent magnet 401 and the second permanent magnet 402.

The magnetic air gap 35 and the magnetic air gap 41 have the functions described below. The magnetic air gap 35 has a side extending in the circumferential direction along the outer circumference of the rotor. Since the magnetic air gap 35 is shaped to extend in the circumferential direction, a bridge portion 39 is formed between the magnetic pole piece portion 34 and the auxiliary magnetic pole portion 33 which are formed by the rotor core on the stator side of the permanent magnets. The bridge portion 39 functions to reduce leakage magnetic flux leaking from the magnetic pole piece portion 34 via the bridge portion 39 to the auxiliary magnetic portion 33. The bridge portion 39 between the magnetic pole piece portion 34 and the auxiliary magnetic pole portion 33 can be formed into the shape extending in the circumferential direction by the circumferentially extending shape of the magnetic air gap 35. The shape of the bridge portion is thinned in the radial direction and lengthened in the circumferential direction. For example, this can make small the value of the magnetic flux content that causes magnetic saturation. With the bridge portion shaped described above, the magnetic resistance of the bridge portion 39 can be increased. Consequently, the amount of the magnetic flux passing through the bridge portion can be reduced, which produces an effect of reducing the leakage magnetic flux. In addition, concentration of centrifugal force on the stator side corner of the magnet insertion hole 6 can be alleviated, which leads to an improvement in mechanical reliability.

Further, if the boundary portion between the auxiliary magnetic pole 33 and the permanent magnet drastically varies in magnetic flux density, torque ripple is likely to occur. However, the magnetic air gaps 35 are provided at the stator-side end portions of the sets of the permanent magnets composed of the first permanent magnets 401 and the second permanent magnets 402 arranged in the V-shape as in the present embodiment. Therefore, the drastic variation in the magnetic flux density can be reduced at the boundary portion between the auxiliary magnetic pole 33 and the permanent magnet. This leads to an effect of reducing the torque triple.

In the present embodiment, the two types of the permanent magnets different from each other in recoil permeability are inserted into the magnet insertion hole 6. The permanent magnets are each arranged so that the magnetization easy axis thereof may extend in the direction along the magnetic circuit of the magnetic flux φd. Incidentally, the magnetization easy axis of the permanent magnet means a direction where the magnet is easily magnetized. The first permanent magnet 401 and the second permanent magnet 402 shown in FIGS. 2 and 3 are each shaped into a general rectangular parallelepiped. The permanent magnet is made so that its short-side direction may be the magnetization easy axis. The permanent magnet is disposed so that the magnetization easy axis may extend in the direction along an arrow X in FIG. 2. The direction along the arrow X is the direction of the magnetic flux φd of the d-axis.

The two or more types of the permanent magnets different from each other in recoil permeability are inserted into and secured in the magnetic insertion hole 6 in the present embodiment. Therefore, the volume that accounts for a portion of the rotor in order to hold the magnets can be reduced, leading to the downsizing of the rotor. The configuration of the present embodiment easily improves the mechanical strength of the rotor compared with the case where two types of permanent magnets different from each other in recoil permeability are disposed at respective different positions. Further, the insertion work for the two types of permanent magnets is easy. In the case of the configuration of the present embodiment, the materials for the first permanent magnet 401 and the second permanent magnet 402 that are not magnetized are inserted into and held in a common magnet insertion hole 6. In this way, the materials for the two types of permanent magnets are inserted and thereafter magnetizing work can be done at one time. Therefore, the magnetizing work facilitates.

A description is given of the permanent magnets different from each other in recoil permeability to be inserted into and held in the magnet insertion hole 6. FIG. 4 is a magnetic signature of a permanent magnet with high recoil permeability. Specifically, FIG. 4 is a magnetic signature of an AlNiCo magnet. Incidentally, although recoil permeability is a technical term that is academically defined, it is briefly explained below.

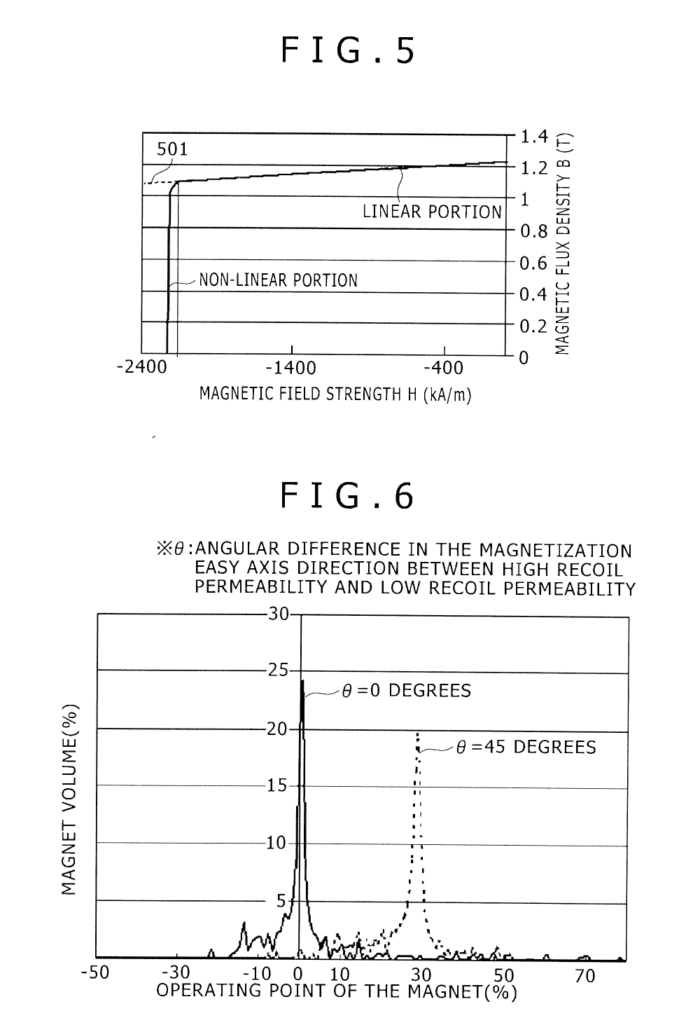

FIG. 5 is a magnetic signature of a permanent magnet with low recoil permeability. Specifically, FIG. 5 is a magnetic signature of a neodymium magnet. The slope 501 of a portion keeping linearity is called recoil permeability in the magnetic signature depicted in FIGS. 4 and 5. Although described above, the recoil permeability of the AlNiCo magnet shown in FIG. 4 is approximately 3.6, and the recoil permeability of the neodymium magnet shown in FIG. 5 is approximately 1.05. Incidentally, the neodymium magnet having a recoil permeability of approximately 1.05 and the ferrite magnet having a recoil permeability of approximately 1.15 are called the permanent magnet with low recoil permeability. On the other hand, a permanent magnet having a recoil permeability of 2 or more, preferably, 3 or more, e.g., an AlNiCo magnet having a recoil permeability of approximately 3.6 is called a permanent magnet with high recoil permeability.

The above recoil permeability means a rate at which the magnetization of a permanent magnet decreases when a magnetic field is applied thereto in a direction opposite to the magnetization. This means that the greater the recoil permeability, the more the magnetic flux of the permanent magnet is easily to decrease. In the magnetic property of these permanent magnets, the magnetic field may be applied thereto in the direction opposite to the magnetization direction of the permanent magnet. In such a case, if the oppositely-oriented magnetic field is stopped in the range where the recoil permeability keeps the linearity, the magnetization of the permanent magnet is restored to its original state. However, the oppositely-oriented magnetic field having such intensity as to reach the range where the recoil permeability does not keep the linearity may be applied thereto. In such a case, even if the oppositely-oriented magnetic field is stopped, the magnetization of the permanent magnet is not restored to the original state. In these phenomena, the former restoring state is called the reversible demagnetization and the latter not-restoring state is called the irreversible demagnetization. The range where recoil permeability keeps the above linearity is not limited to the range where recoil permeability keeps the complete linearity but includes also a range where the recoil permeability has near-linearity. The magnetic field in the direction opposite to that of the magnetization can be applied by allowing a negative current (hereinafter, called the field weakening current) to flow to the d-axis if a pole-central axis is the d-axis. This field weakening current is a method used to hold and suppress at a constant level back-EMF which increases in proportion to rotational speed during the high-speed operation of the electric rotating machine.

According to the first embodiment described above, the permanent magnet with high recoil permeability is inserted into the magnet insertion hole. This reduces the magnetic flux generated by the permanent magnet with high recoil permeability if the field weakening current is allowed to flow during high-speed operation. The reduction of the magnetic flux φd of the d-axis is increased compared with the conventional field weakening current. Consequently, the linkage flux due to the magnetic flux φd of the d-axis is reduced. This suppresses an increase in back-EMF along with the increased rotational speed, which can improve the limit of the high-speed rotation that can be used by the electric rotating machine. In addition, since the field weakening current can be reduced compared with the high-speed operation of the conventional electric rotating machine, the efficiency of the electric rotating machine during the high-speed operation is improved.

Furthermore, the permanent magnet with low recoil permeability and the permanent magnet with high recoil permeability are disposed in the same magnet insertion hole. The permanent magnet with low recoil permeability has large coercivity; therefore, it can assist the permanent magnet with high recoil permeability, so that the magnetic field applied to the permanent magnet with high recoil permeability is reduced. Thus, it becomes hard for the permanent magnet with high recoil permeability to be irreversibly demagnetized.

FIG. 6 shows the relationship between the operating point of the magnet and an angular difference in magnetization easy axis direction between a second permanent magnet with high recoil permeability and a first permanent magnet with low recoil permeability. FIG. 6 shows that the closer to 0% a peak value of magnet volume (a vertical axis) lies on the operating point (a horizontal axis), the harder it is for the permanent magnet to be irreversibly demagnetized. When the angular difference in the magnetization easy axis direction between the permanent magnet with high recoil permeability and the permanent magnet with low recoil permeability is set at θ=0, if the operating point of the magnet is near 0%, the magnet volume peaks at approximately 24%. When the angular difference in the magnetization easy axis direction between the permanent magnet with high recoil permeability and the permanent magnet with low recoil permeability is set at θ=45, if the operating point of the magnet is near 300, the magnet volume peaks at approximately 20%.

These results show the following: The angular difference in the magnetization easy axis direction between the permanent magnet with high recoil permeability and the permanent magnet with low recoil permeability is set at θ=0. In other words, the magnetization easy axis direction of the permanent magnet with high recoil permeability is made parallel to that of the permanent magnet with low recoil permeability. This allows the permanent magnet with high recoil permeability to have a small operating point. Thus, it is harder for the permanent magnet with high recoil permeability to be irreversibly demagnetized. Consequently, a magnetization circuit for re-magnetization is unnecessary. Thus, the number of component parts as a system can be reduced. Incidentally, the permanent magnet with high recoil permeability is disposed at a position where its average radius is smaller than that of the permanent magnet with low recoil permeability. However, their positions may be reversed.

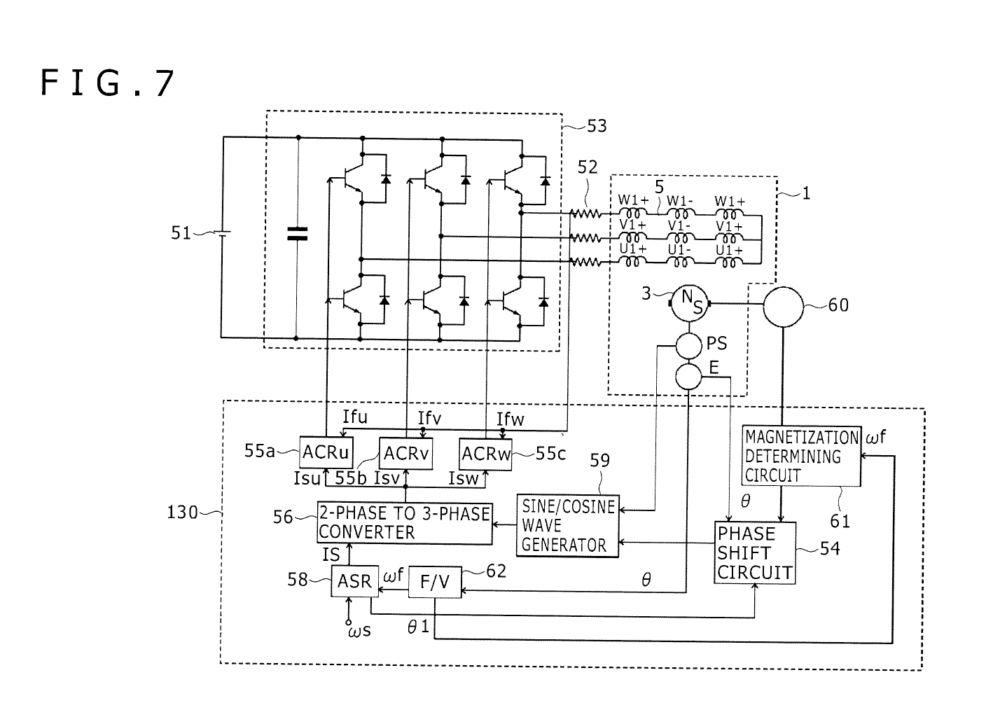

The configuration of an electric rotating machine system of the present embodiment is next described with reference to FIG. 7. The electric rotating machine 1 of the first embodiment includes the electric rotating machine 1, a DC power source 51 constituting a drive source for the electric rotating machine 1 and a control unit for controlling the power supplied to the electric rotating machine 1 to control driving.

The electric rotating machine 1 using the permanent magnets has the configuration described earlier or a configuration described later. The DC power source 51 may be composed of, for example, an AC power source and a converter section for converting the AC power from the AC power source to DC power. Alternatively, the DC power source 51 may be a lithium ion secondary battery or a nickel ion secondary battery mounted on a vehicle. The control unit is an inverter device, which receives DC power from the DC power source 51, converts the DC power to AC power and supplies the AC power to the stator windings 5 of the electric rotating machine 1. The inverter device includes a power system inverter circuit 53 (a power conversion circuit) electrically connected between the DC power source 51 and the stator windings 5, and a control circuit 130 for controlling the operation of the inverter circuit 53.

The inverter circuit 53 has a bridge circuit composed of switching semiconductor devices, e.g., MOS-FET (metal-oxide semiconductor field-effect transistors), or IGBT (insulated-gate bipolar transistors). The inverter circuit 53 converts the DC power from a smoothing capacitor module into AC power, or converts the AC power generated by the electric rotating machine into DC power. The bridge circuit mentioned above is configured such that high potential side switches, low potential side switches and series circuits, which are called arms, are electrically connected to one another in parallel in the number equal to that of the phases of the electric rotating machine 1. In the present embodiment where three-phase AC power is generated, the bridge circuit has three sets of the arms. The high potential side switch of each arm has a terminal electrically connected to the positive terminal of the DC power source 51. In addition, the low potential side switch has a terminal electrically connected to the negative terminal of the DC power source 51. A connecting point between an upper switching semiconductor device and a lower switching semiconductor device of each arm is electrically connected to the stator windings 5 of the electric rotating machine 1 so that phase voltage may be supplied from the connecting point to the stator windings 5.

A phase current supplied from the inverter circuit 53 to the stator windings 5 is measured by a current detector 52 installed on a bus bar for each phase to supply AC power to the electric rotating machine. The current detector 52 is e.g. a current transformer. The control circuit 130 operates to control the switching action of the switching semiconductor devices of the inverter circuit 53 to provide target torque on the basis of input information including torque commands and braking commands. The input information includes, for example, a current command signal Is, i.e., torque demanded for the electric rotating machine 1, and a magnetic pole position θ of the rotor 3 of the electric rotating machine 1. The current command signal Is, i.e., demanded torque, is obtained by being calculated in the control circuit 130 on the basis of a command sent from an upper controller in response to demand such as an accelerator operation amount demanded by a driver in the case of a vehicle. The magnetic pole position θ is detection information obtained from the output of the magnetic pole position detector PS.

A speed control circuit 58 calculates a speed difference ωe from a speed command ωs and actual speed ωf and exercises PI control on the speed difference ωe and outputs the current command Is, i.e., torque command and a rotational angle θ1 of the rotor 3. The speed command ωs is created based on the demand command of the upper controller. The actual speed ωf is real speed which is obtained from the positional information θ1 from the encoder via an F/V converter 61 that is adapted to convert a frequency to voltage. The above PI control is a generally used control system which uses a proportional term P multiplying a deviation value by a proportional constant and an integral term I.

A phase shift circuit 54 phase-shifts and outputs a rotation-synchronized pulse generated by the rotational speed detector E, i.e., the position information θ of the rotor 3 in response to the command of the rotational angle θ1 from the speed control circuit 58. The phase shift is designed to move forward, for example, the resultant vector of armature magnetomotive force created by the current flowing in the stator windings 5, by an electric angle of 90 degrees or more with respect to the direction of the magnetic flux or field made by the permanent magnet 400.

A sine/cosine wave generating circuit 59 generates sine wave output resulting from phase-shifting the back-EMF of each winding of the stator windings 5 on the basis of the magnetic pole position of the permanent magnet 400 of the rotor 3 detected by the magnetic pole position detector PS and the phase-shifted position information θ of the rotor from the phase shift circuit 54. Incidentally, a phase-shift amount includes also a value of zero.

A 2-phase to 3-phase converter circuit 56 outputs current commands Isu, Isv, Isw of each phase in response to a current command IS from the speed control circuit 58 and the output of the sine/cosine wave generating circuit 59. The phases have respective individual current control systems 55a, 55b, 55c. The current control systems 55a, 55b, 55c send respective signals corresponding to the current commands Isu, Isv, Isw and current detection signals Ifu, Ifv, Ifw from the current detector 52 to the inverter circuit 53 for controlling the switching action of the switching semiconductor devices. In this way, each phase current of three-phase alternating current is controlled. In this case, the current of the combined phase is controlled perpendicularly to field magnetic flux or controlled to the phase-shifted position. Thus, the property equal to that of a DC machine can be provided without a commutator.

The signals outputted from the current control systems 55a, 55b, 55c of the respective phases of the AC current are each sent to a corresponding one of the control terminals of the switching semiconductor devices constituting the arms of the phases. In this way, each of the switching semiconductors performs switching action, which is on-off operation, so that the DC power supplied from the DC power source 51 via the smoothing capacitor module is converted into AC power. The AC power is supplied to the corresponding phase windings of the stator windings 5.

The inverter device of the first embodiment constantly forms a current (a phase current flowing in each phase winding) flowing in the stator windings 5 so that the resultant vector of the armature magnetomotive force flowing in the stator windings 5 may be perpendicular to or phase-shifted with respect to the direction of the magnetic flux or field made by the permanent magnet 400. In this way, the electric rotating machine system can provide the property equal to that of the DC machine by the use of the commutatorless, i.e., brushless electric rotating machine 1. Incidentally, the field weakening current is used to exercise control to constantly form a current (a phase current flowing in each phase winding) flowing in the stator windings 5 so that the resultant vector of the armature magnetomotive force made by the current flowing in the stator windings 5 may move forward by 90 degrees (an electric angle) or more with respect to the direction of the magnetic flux or field made by the permanent magnet 400.

The electric rotating machine system of the first embodiment controls the current (the phase current flowing in each phase winding) flowing in the stator windings 5 on the basis of the magnetic pole position of the rotor 3 so that the resultant vector of the armature magnetomotive force made by the current flowing in the stator windings 5 may be perpendicular to the direction of the magnetic flux or field made by the permanent magnet 400. Thus, the electric rotating machine 1 can continuously output the maximum torque. When the field weakening control is necessary, it is needed only to control the current (the phase current flowing in each phase winding) flowing in the stator windings 5 on the basis of the magnetic pole position of the rotor 3 so that the resultant vector of the armature magnetomotive force made by the current flowing in the stator windings 5 may move forward by 90 degrees (electric angle) or more with respect to the direction of the magnetic flux or field made by the permanent magnet 400.

A description is next given of magnetization determination and magnetization method encountered when the second permanent magnet 402 with high recoil permeability is operated in the range of irreversible demagnetization. The electric rotating machine 1 is further equipped with a magnetic flux detector 60, which outputs flux content. A magnetization determining circuit 61 receives a value representing the flux content and the actual speed of outputted by the F/V converter 62 and determines whether or not re-magnetization is necessary. If the magnetic flux based on the field weakening current is applied to the permanent magnet 400, a strong magnetic flux that exceeds the range of reversible demagnetization may be applied to the permanent magnet. In such a case, the permanent magnet, particularly, the second permanent magnet may be likely to be demagnetized. If the permanent magnet is irreversibly magnetized as mentioned above, then the flux content generated by the permanent magnet is reduced. Therefore, the permanent magnet needs to be re-magnetized. If it is determined that the re-magnetization of the permanent magnet is needed, the magnetization determination circuit 61 issues a magnetization command to the phase shift circuit 54.

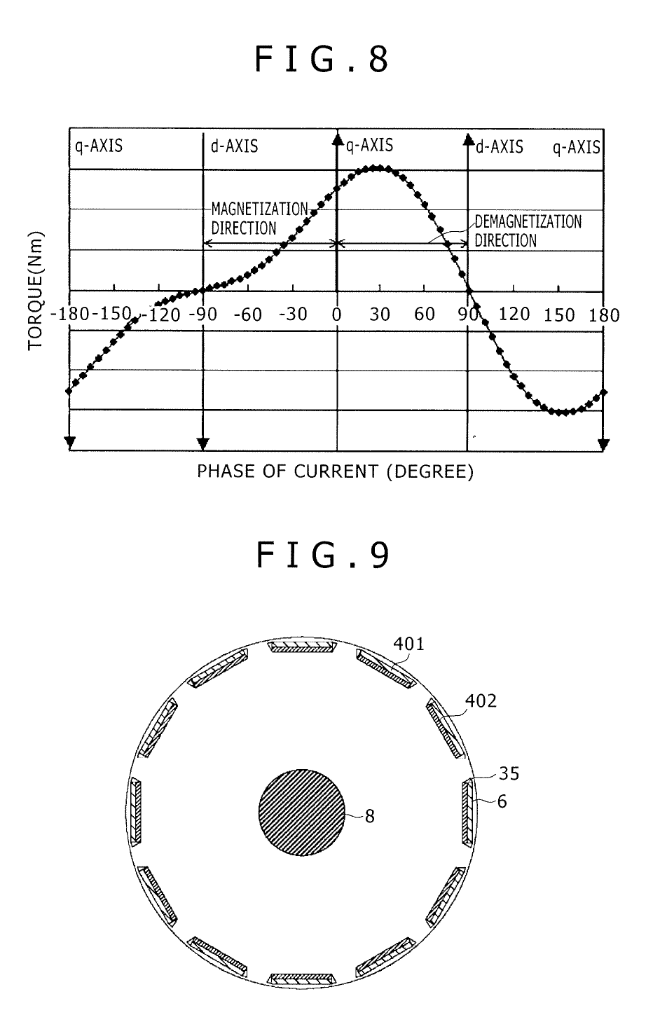

A description is next given of a method for magnetizing the second permanent magnet 402 when the magnetization determination circuit 61 issues the magnetization command to the phase shift circuit 54. It goes without saying that a special magnetization circuit may be used for magnetization. However, a certain level of re-magnetization is possible by the use of the above-mentioned control circuit 130 without use of the special magnetization circuit. FIG. 8 shows the relationship between the phase of current and torque of the above-described electric rotating machine incorporating the permanent magnets. In FIG. 8, 0 degrees of the phase of current is on the q-axis. If the permanent magnet 400, particularly, the second permanent magnet 402 is irreversibly demagnetized, the current flowing in the stator windings 5, i.e., the phase current flowing in each phase winding is controlled so that the resultant vector of the armature magnetomotive force created by the current flowing in the stator windings 5 may move backward at an electric angle of approximately 90 degrees or more with respect to the direction of the magnetic flux or field made by the permanent magnet 400. The phase current supplied to the stator windings 5 is controlled as described above, so that the resultant vector of the armature magnetomotive force made by the current flowing in the stator windings 5 is oriented in the magnetization direction with respect to the magnetization of the permanent magnet 400. Therefore, the permanent magnets 400, particularly, the second permanent magnet 402 can be magnetized, that is, the magnetized state that has been demagnetized can be strengthened again.

### Embodiment 2

A second embodiment of the present invention is next described with reference to FIG. 9. FIG. 9 is a cross-sectional view taken along a plane vertical to a rotational axis of a rotor 3 of an electric rotating machine according to the second embodiment of the invention. A stator of the second embodiment is the same as that of the embodiment described above and description thereof is omitted here. The second embodiment is different from the first embodiment in that permanent magnets forming a magnet pole are composed of a set of first permanent magnet and second permanent magnet. A single magnet insertion hole is formed for each magnet pole. These permanent magnets have respective magnetization easy axes extending along the magnetic circuit of a d-axis. Specifically, the magnetization easy axes are oriented in the radial direction of the rotor 3. In the second embodiment, the first permanent magnet and the second permanent magnet are each shaped into a general rectangular parallelepiped. A magnetic air gap 35 is formed at both circumferential ends of the first and second permanent magnets. As described earlier, a rotor core on the outer circumferential side of the first permanent magnet and the second permanent magnet acts as a magnetic pole piece portion. In addition, a rotor core on the outer circumferential side of the magnetic air gap 35 acts as a bridge portion. An auxiliary magnet pole is formed between magnetic poles adjacent to each other. The magnetic pole piece portion, the magnetic air gap 35, the bridge portion and the auxiliary magnetic pole portion have the respective configurations described in the first embodiment and each of them has basically the same function and effect as those of the first embodiment.

In the second embodiment depicted in FIG. 9, the first permanent magnet 401 and the second permanent magnet 402 for forming each magnet pole are shaped into the general rectangular parallelepiped. However, also the first permanent magnet 401 and the second permanent magnet 402 shaped into a circle or a semicircle produce the same function and effect. Incidentally, the permanent magnet with high recoil permeability is disposed at a position where its average radius is smaller than that of the permanent magnet with low recoil permeability. However, their positions may be reversed.

According to the second embodiment, the permanent magnet with high recoil permeability is received in the magnet insertion hole 6. This produces the same function and effect as those of the first embodiment. That is to say, if a field weakening current is allowed to flow during high-speed operation, linkage flux caused by the permanent magnet with high recoil permeability is reduced. Therefore, an increase in back-EMF is suppressed, which can increase the maximum rotational speed. Further, the permanent magnet with low recoil permeability and the permanent magnet with high recoil permeability are arranged in the same magnet insertion hole. A magnetic field applied to both the permanent magnets can be shared by them; therefore, it becomes hard for the permanent magnets to be irreversibly demagnetized. Thus, a magnetization circuit for re-magnetization becomes unnecessary, which can reduce the number of component parts as a system.

### Embodiment 3

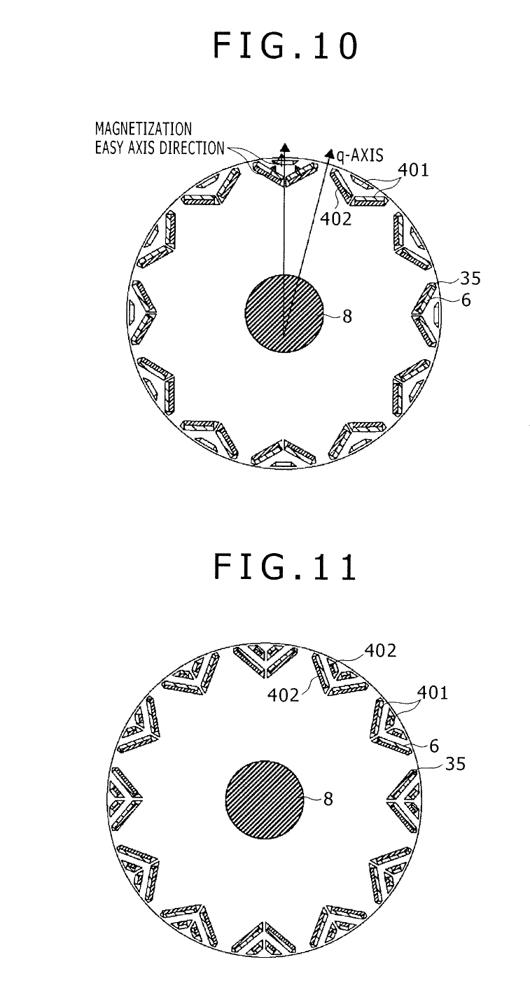

A third embodiment of the present invention is next described with reference to FIG. 10. FIG. 10 is a cross-sectional view taken along a plane vertical to a rotational axis of a rotor 3 of an electric rotating machine according to the third embodiment of the invention. A stator of the third embodiment has basically the same configuration, function and effect as those of the first embodiment described above and therefore its illustration and explanation are omitted. The third embodiment is different from the first embodiment in the following points. A first permanent magnet 401 is additionally disposed on the stator side of the V-shaped permanent magnets, i.e., of the two sets of the first permanent magnets 401 and the second permanent magnets 402 shown in the first embodiment. This increases the amount of material for the magnets forming each magnetic pole. Although the third embodiment uses a rectangular parallelepipedic permanent magnet for explanation, a circular or semicircular permanent magnet produces basically the same effects. Here, the permanent magnet with high recoil permeability is disposed at a position where its average radius is smaller than that of the permanent magnet with low recoil permeability. However, their positions may be reversed. Incidentally, the basic operation of the above configuration is as the description of the first or second embodiment and produces the functions and effects described in the first or second embodiment. The descriptions of the magnetic pole piece portion, the magnetic air gap, the bridge portion and the auxiliary magnetic pole portion are basically the same as those of the first or second embodiment and therefore they are omitted.

According to the third embodiment, the permanent magnet with high recoil permeability is received in the magnet insertion hole. With this, if a field weakening current is allowed to flow during high-speed operation, linkage flux caused by the permanent magnet with high recoil permeability is reduced. Therefore, an increase in back-EMF is suppressed, which can increase the maximum rotational speed. Further, the permanent magnet with low recoil permeability and the permanent magnet with high recoil permeability are arranged in the same magnet insertion hole. A magnetic field applied to both the permanent magnets can be shared by them; therefore, it becomes hard for the permanent magnets to be irreversibly demagnetized. Thus, a magnetization circuit for re-magnetization becomes unnecessary, which can reduce the number of component parts as a system. The permanent magnets are disposed on the outside in the outside-diameter direction of the rotor. The magnetization easy axis directions of the permanent magnets are oriented in such three directions as to coincident with or intersect the d-axis. In this way, the magnetic flux density made by the rotor can be approximated to a sine wave, so that torque pulsation and electromagnetic noise can be reduced.

### Embodiment 4

A fourth embodiment of the present invention is next described with reference to FIG. 11. FIG. 11 is a cross-sectional view of a rotor of an electric rotating machine according to a fourth embodiment of the invention. A stator of the fourth embodiment has basically the same configuration, function and effect as the contents of the description of the first embodiment and therefore their explanations are omitted. The fourth embodiment is different from the first embodiment in that permanent magnets are further installed in a V-shaped arrangement on the stator side of permanent magnets arranged in a V-shape. This can increase the amount of material for magnets forming each magnetic pole, which can increase magnetic torque. In the fourth embodiment, the permanent magnets different from each other in recoil permeability are inserted into magnet insertion holes on both inner and outer circumferences. However, even if they are inserted into the magnet insertion holes on any one of the inner and outer circumferences, the effect is produced. If all poles or at least one pole is configured as above, the effect is produced. Further, although the fourth embodiment uses a rectangular parallelepipedic permanent magnet for explanation, also a circular or semicircular permanent magnet produces basically the same effect. Here, the permanent magnet with high recoil permeability is disposed at a position where its average radius is smaller than that of the permanent magnet with low recoil permeability. However, even if their positions are reversed, the same effect can be produced.

According to the fourth embodiment, the permanent magnet with high recoil permeability is inserted into the magnet insertion hole. With this, if a field weakening current is allowed to flow during high-speed operation, the interlinkage flux caused by the permanent magnet with high recoil permeability is reduced. Thus, the maximum rotational speed can be increased. Further, the permanent magnet with low recoil permeability and the permanent magnet with high recoil permeability are disposed in the same magnet insertion hole. A magnetic field applied to both the permanent magnets can be shared by them. Therefore, it becomes hard for the permanent magnets to be irreversibly demagnetized. Thus, a magnetization circuit for re-magnetization becomes unnecessary, which can reduce the number of component parts as a system.

Further, two layers of the magnet insertion holes shaped in a V-shape are provided; therefore, reluctance torque is increased, which makes it possible to downsize the electric rotating machine.

### Embodiment 5

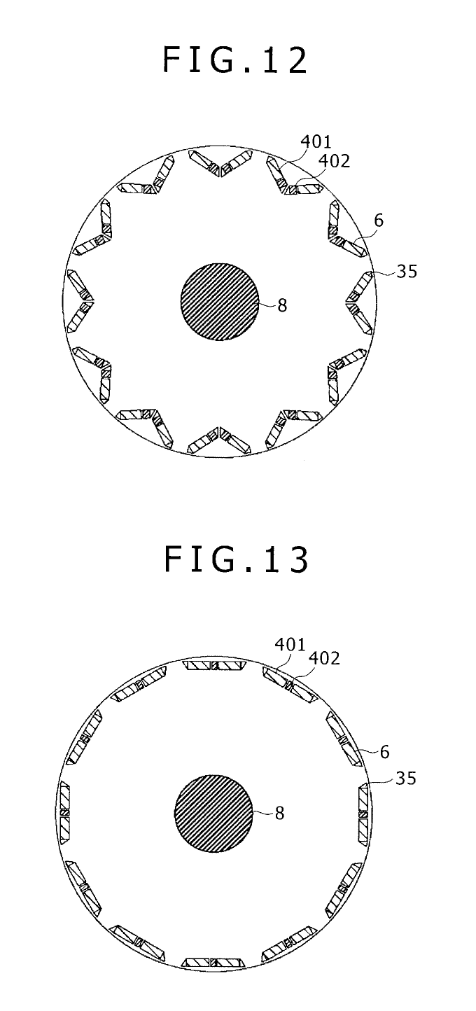

A fifth embodiment of the present invention is next described with reference to FIG. 12. FIG. 12 is a cross-sectional view taken along a plane vertical to a rotational axis of a rotor of an electric rotating machine according to the fifth embodiment of the invention. The basic configuration, function and effect of the fifth embodiment are basically the same as those of the first embodiment. A stator of the fifth embodiment has basically the same configuration, function and effect as those of the first embodiment described above and therefore its illustration and explanation are omitted.

The fifth embodiment is different from the first embodiment in that a permanent magnet with high recoil permeability and a permanent magnet with low recoil permeability are disposed in respective different magnet insertion holes. Further, the permanent magnet with high recoil permeability is disposed near the center of a pole. If all poles or at least one pole is configured as above, the effect is naturally produced. Further, although a rectangular parallelepipedic permanent magnet is used for explanation in the fifth embodiment, also a circular or semicircular permanent magnet produces the same effect. Here, the permanent magnet with high recoil permeability is disposed at a position where its average radius is smaller than that of the permanent magnet with low recoil permeability. However, even if their positions are reversed, the same effect can be produced.

According to the fifth embodiment, the permanent magnet with high recoil permeability is inserted into the magnet insertion hole. With this, if a field weakening current is allowed to flow during high-speed operation, the interlinkage flux caused by the permanent magnet with high recoil permeability is reduced to suppress an increase in back-EMF. Thus, the maximum rotational speed can be increased. Further, the permanent magnet with high recoil permeability is disposed near the center of a pole; therefore, it becomes hard for an oppositely-oriented magnetic field to be applied thereto. Thus, it becomes hard for the permanent magnet with high recoil permeability to be irreversibly demagnetized. Further, the permanent magnet with high recoil permeability and the permanent magnet with low recoil permeability are disposed in the respective different magnet insertion holes and therefore they have an iron bridge portion therebetween. A demagnetization field coefficient with respect to the magnetization easy axis direction of each of the permanent magnets is reduced. Thus, it becomes hard for the permanent magnet to be irreversibly demagnetized.

The magnet insertion hole is shared by the first and second permanent magnets, which are arranged in the stacked manner in the first embodiment. However, the first and second permanent magnets may be arranged in a row. In this case, the magnet flux of a d-axis is composed of the magnetic flux generated by the first and second permanent magnets. In addition, the first and second permanent magnets 401, 402 are arranged so that their magnetization easy axis directions may extend in the direction along the magnetic flux of the d-axis.

### Embodiment 6

A sixth embodiment of the present invention is described with reference to FIG. 13. FIG. 13 is a cross-sectional view taken along a plane vertical to a rotational axis of a rotor of an electric rotating machine according to the sixth embodiment of the invention. The basic configuration, function and effect of the sixth embodiment are basically the same as those of the first or second embodiment. A stator of the sixth embodiment has basically the same configuration, function and effect as those of the first embodiment and therefore the illustration and explanation of the stator are omitted.

The sixth embodiment is different from the second embodiment described with reference to FIG. 9 in that a permanent magnet with high recoil permeability and a permanent magnet with low recoil permeability are disposed in respective different magnet insertion holes. Further, the permanent magnet with high recoil permeability is disposed near the center of a pole. If all poles or at least one pole is configured as above, the effect is naturally produced. Further, although a rectangular parallelepipedic permanent magnet is used for explanation in the sixth embodiment, also a circular or semicircular permanent magnet produces the same effect. Here, the permanent magnet with high recoil permeability is disposed at a position where its average radius is smaller than that of the permanent magnet with low recoil permeability. However, even if their positions are reversed, the same effect can be produced.

According to the sixth embodiment described above, the permanent magnet with high recoil permeability is inserted into the magnet insertion hole. With this, if a field weakening current is allowed to flow during high-speed operation, the interlinkage flux caused by the permanent magnet with high recoil permeability is reduced to suppress an increase in back-EMF. Thus, the maximum rotational speed can be increased. Further, the permanent magnet with high recoil permeability is disposed near the center of a pole; therefore, it becomes hard for an oppositely-oriented magnetic field to be applied thereto. Thus, it becomes hard for the permanent magnet with high recoil permeability to be irreversibly demagnetized. Further, the permanent magnet with high recoil permeability and the permanent magnet with low recoil permeability are disposed in the respective different magnet insertion holes and therefore they have an iron bridge portion therebetween. A demagnetization field coefficient with respect to the magnetization easy axis direction of each of the permanent magnets is reduced. Thus, it becomes hard for the permanent magnet to be irreversibly demagnetized.

### Embodiment 7

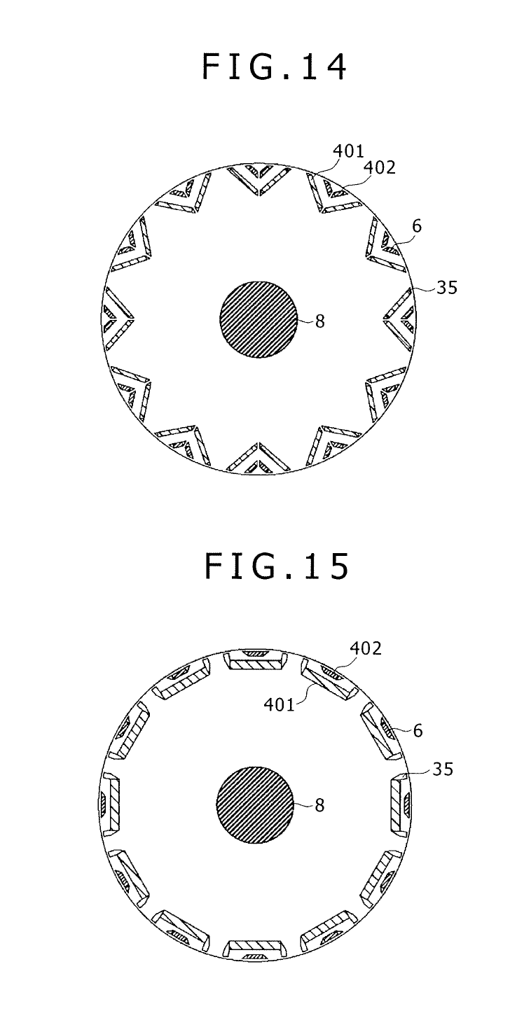

A seventh embodiment of the present invention will be described with reference to FIG. 14. FIG. 14 is a cross-sectional view of a rotor of an electric rotating machine according to the seventh embodiment of the invention. The basic configuration, function and effect of the seventh embodiment are basically the same as those of the first or fourth embodiment. A stator of the seventh embodiment has basically the same configuration, function and effect as those of the first embodiment and therefore the illustration and explanation of the stator are omitted.

The seventh embodiment is different from the seventh embodiment in that a permanent magnet with high recoil permeability and a permanent magnet with low recoil permeability are disposed in respective different magnet insertion holes. If all poles or at least one pole is configured as above, the effect is naturally produced. Further, although a rectangular parallelepipedic permanent magnet is used for explanation in the seventh embodiment, also a circular or semicircular permanent magnet produces the same effect. Here, the permanent magnet with high recoil permeability is disposed at a position where its average radius is smaller than that of the permanent magnet with low recoil permeability. However, even if their positions are reversed, the same effect can be produced.

According to the seventh embodiment described above, the permanent magnet with high recoil permeability is inserted into the magnet insertion hole. With this, if a field weakening current is allowed to flow during high-speed operation, the interlinkage flux caused by the permanent magnet with high recoil permeability is reduced to suppress an increase in back-EMF. Thus, the maximum rotational speed can be increased. Further, two layers of the magnet insertion holes each shaped in a V-shape are provided; therefore, reluctance torque is increased, which makes it possible to downsize the electric rotating machine.

### Embodiment 8

An eighth embodiment of the present invention will be described with reference to FIG. 15. FIG. 15 is a cross-sectional view taken along a plane vertical to a rotational axis of an electric rotating machine according to the eighth embodiment of the invention. The basic configuration, function and effect of the eighth embodiment are basically the same as those of the first or second embodiment. A stator of the eighth embodiment has basically the same configuration, function and effect as those of the first or sixth embodiment and therefore the illustration and explanation of the stator are omitted.

The eighth embodiment is different from the sixth embodiment shown in FIG. 9 in that a permanent magnet with high recoil permeability and a permanent magnet with low recoil permeability are disposed in respective different magnet insertion holes. If all poles or at least one pole is configured as above, the effect is naturally produced. Further, a rectangular parallelepipedic permanent magnet is used for explanation in the eighth embodiment. However, also a circular or semicircular permanent magnet produces the same effect. Here, the permanent magnet with high recoil permeability is disposed at a position where its average radius is smaller than that of the permanent magnet with low recoil permeability. However, even if their positions are reversed, the same effect can be produced.

According to the eighth embodiment described above, the permanent magnet with high recoil permeability is inserted into the magnet insertion hole. With this, if a field weakening current is allowed to flow during high-speed operation, the interlinkage flux caused by the permanent magnet with high recoil permeability is reduced to suppress an increase in back-EMF. Thus, the maximum rotational speed can be increased.

Further, two layers of the magnet insertion holes are formed; therefore, reluctance torque is increased, which makes it possible to downsize the electric rotating machine.

### Embodiment 9

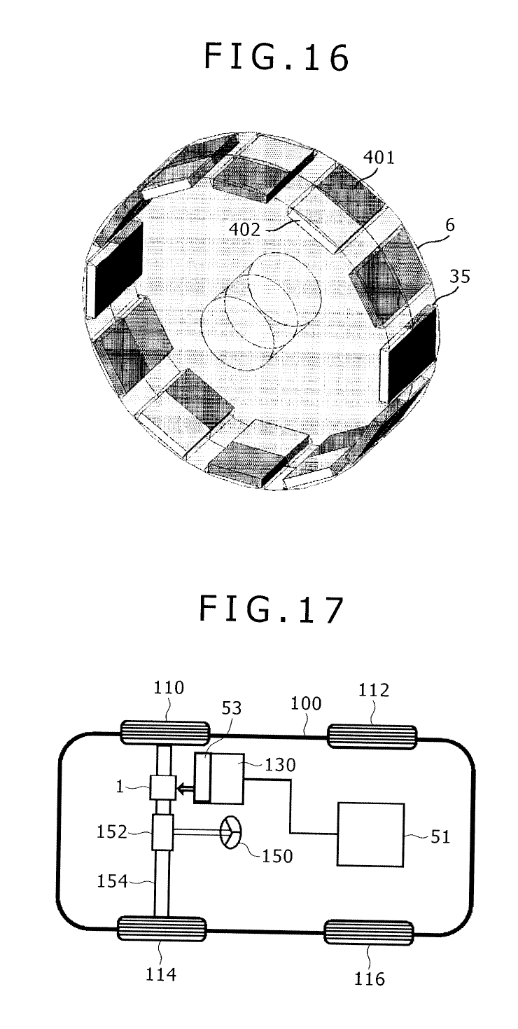

A ninth embodiment of the present invention is described with reference to FIG. 16. The above embodiments describe the two-dimensional sectional structures. The present embodiment uses a rotor divided into a plurality of parts in the direction of a rotational axis and two or more types of permanent magnets different from each other in recoil permeability. FIG. 16 is a perspective view of an electric rotating machine according to the ninth embodiment of the present invention. A stator has almost the same configuration, function and effect as those of the first embodiment; therefore, its illustration and explanation are omitted.

A feature is here to use the two or more types of permanent magnets different from each other in recoil permeability in the direction along the rotational axis. If all poles or at least one pole is configured as above, the effect is naturally produced. Although a rectangular parallelepipedic permanent magnet is used for explanation in the ninth embodiment, also a circular or semicircular permanent magnet produces the same effect. Here, the permanent magnet with high recoil permeability is disposed at a position where its average radius is smaller than that of the permanent magnet with low recoil permeability. However, even if their positions are reversed, the same effect can be produced.

According to the ninth embodiment described above, a permanent magnet with high recoil permeability is inserted into a magnet insertion hole. With this, if a field weakening current is allowed to flow during high-speed operation, the interlinkage flux caused by the permanent magnet with high recoil permeability is reduced to suppress an increase in back-EMF. Thus, the maximum rotational speed can be increased. The internal-rotation type electric rotating machines are described above; however, the present invention can be applied also to external-rotation type electric rotating machines. Additionally, the present invention can be applied also to both distributed-winding electric rotating machines and concentrated-winding electric rotating machines.

### Embodiment 10

A tenth embodiment is next described with reference to FIG. 17. The tenth embodiment applies the present invention to an electric vehicle to which the first to ninth embodiments are applied. FIG. 17 is a block diagram of the electric vehicle to which the invention is applied.

A body 100 of the electric vehicle is supported by four wheels 110, 112, 114, 116. This electric vehicle is of front-wheel drive. An electric rotating machine 1 which develops running torque or braking torque is mechanically connected to a front axle 154. Rotary torque developed by the electric rotating machine 1 is transmitted by a mechanical transmission mechanism. The electric rotating machine 1 is driven by the three-phase AC power generated by the control unit 130 and the inverter circuit 53 which are described with FIG. 7 and the drive torque is controlled.

The DC power source 51 composed of a high-voltage battery such as a lithium secondary battery is installed as a power source for the control unit 130. The DC power from the DC power source 51 is converted into AC power by the switching action of the inverter circuit 53 based on the control of the control unit 130. The AC power is supplied to the electric rotating machine 1. The wheels 110, 114 are driven by the rotary torque of the electric rotating machine 1, so that the vehicle travels.

When a driver puts on brake, the control unit 130 reverses the phase of the AC power with respect to the magnetic pole of the rotor, the AC power being generated by the inverter circuit. This allows the electric rotating machine to operate as a generator, thereby performing regenerative braking operation. The electric rotating machine 1 develops the rotary torque in the direction of suppressing running to generate a braking force against the running of the vehicle 100. At this time, the kinetic energy of the vehicle is converted into electric energy, with which the DC power source 51 is charged.

Incidentally, the tenth embodiment describes the electric rotating machine as being used to drive the wheels of the electric vehicle. However, the electric rotating machine can be used as a driving apparatus for electrically-driven vehicles and for electrically-driven construction machines, and as the other driving apparatus. Incidentally, if the electric rotating machine according to the present embodiment is applied to an electrically-driven vehicle, particularly, to an electric vehicle, the maximum rotational speed can be increased, whereby the high-power electric vehicle can be provided.

### EXPLANATION OF REFERENCE NUMERALS

1 Electric rotating machine
2 Stator
30 Rotor
4 Stator core
5 Stator winding
6 Magnet insertion hole
7 Rotor core
8 Shaft
9 End bracket
10 Bearing
11 Housing
21 Yoke portion of the stator
22 Teeth portion
23 Slot
33 Auxiliary magnetic pole portion
34 Magnetic pole piece portion
35 Magnetic air gap
51 DC power source
52 Current detector
53 Inverter circuit
54 Phase shift circuit
400 Permanent magnet
401 First permanent magnet
402 Second permanent magnet
E Rotational speed detector

1. An electric rotating machine comprising:
a stator having a stator core and stator windings wound around the stator core, the stator core having slots extending along a full circumference thereof; and
a rotor installed rotatably with respect to the stator;
wherein the rotor includes
a rotor core having electromagnetic steel sheets laminated in a direction along a rotational axis of the rotor, the rotor core being formed with a plurality of magnetic poles arranged in a circumferential direction; and
a plurality of first permanent magnets and a plurality of second permanent magnets for forming the plurality of corresponding magnetic poles; and
wherein the first permanent magnet and the second permanent magnet for forming each of the magnetic poles of the rotor are different in recoil permeability from each other.

2. The electric rotating machine according to claim 1,
wherein the second permanent magnet is disposed so that a magnetization easy axis of the second permanent magnet forming each of the magnetic poles of the rotor is disposed along magnetic flux of a d-axis made by the first permanent magnet.

3. The electric rotating machine according to claim 1,
wherein the rotor core of the electric rotating machine is formed with a magnetic insertion hole adapted to receive permanent magnets for forming each magnetic pole, and the first permanent magnet and the second permanent magnet are received and held in the magnet insertion hole.

4. The electric rotating machine according to claim 1,
wherein the first permanent magnet has a coercivity property higher than that of the second permanent magnet, and
wherein the second permanent magnet has recoil permeability higher than that of the first permanent magnet.

5. The electric rotating machine according to claim 4,
wherein the first permanent magnet is a neodymium magnet or a ferrite magnet and the second permanent magnet is an AlNiCo magnet.

6. The electric rotating machine according to claim 1,
wherein the rotor has auxiliary magnetic poles each formed between magnetic poles adjacent to each other among a plurality of magnetic poles formed along the circumferential direction, and a magnetic circuit is formed through which magnetic flux of a q-axis generated by the stator windings passes via the auxiliary magnetic pole.

7. The electric rotating machine according to claim 6,
wherein the rotor has the magnet insertion holes formed along the circumferential direction so as to correspond to the associate magnetic poles, the magnet insertion holes being each adapted to receive the first permanent magnet and the second permanent magnet forming a corresponding one of the magnetic poles arranged in the circumferential direction, the magnet insertion hole being shaped to have a circumferential length greater than a radial length;
wherein the magnetic insertion hole is shaped such that a side located on the outer circumferential side of the rotor has a length greater than a side located on a central side of the rotor;
wherein the first permanent magnet and the second permanent magnet are fixedly received in the magnet insertion hole in a laminated state in the radial direction of the rotor, and the first permanent magnet and the second permanent magnet are magnetized along the radial direction of the rotor in such a manner as to have respective magnetized polarities alternately reversed for each magnetic pole; and
wherein magnetic air gaps are provided inside each of the magnet insertion holes at both circumferential ends of at least a permanent magnet located on an outer circumferential side of the first and second permanent magnets.

8. The electric rotating machine according to claim 7,
wherein a magnetic pole piece portion is formed in the rotor core between the outer circumferential side of the magnet insertion hole for each magnetic pole and the outer circumference of the rotor core, and a magnetic circuit is formed in which the magnetic flux of the d-axis generated by the first and second permanent magnets passes through the magnetic pole piece portion and the stator core and intersects the stator windings.

9. The electric rotating machine according to claim 6,
wherein at least two sets of the first permanent magnets and the second permanent magnets for forming each magnetic pole are installed in the rotor so as to correspond to each of the magnetic poles arranged in the circumferential direction, and a first magnet insertion hole adapted to receive one set of the first and second permanent magnets of the two sets and a second magnet insertion hole adapted to receive the other set of the first and second permanent magnets are formed so as to correspond to each of the magnetic poles,
wherein the first magnet insertion hole and the second magnet insertion hole provided so as to correspond to each of the magnetic poles are formed in a state where an outer circumferential side thereof is more open than a central side thereof, i.e., where ends of the first and second magnet insertion holes on the outer circumferential side of the rotor are more spaced from each other than ends thereof on the central side of the rotor; and
wherein the first permanent magnet and the second permanent magnet are fixedly received in each of the first magnet insertion hole and the second magnet insertion hole in a stacked state.

10. The electric rotating machine according to claim 9,
wherein a magnetic air gap is formed at the outer circumferential-side end portion of each of the first magnet insertion hole and the second magnet insertion hole.

11. The electric rotating machine according to claim 10,
wherein a magnetic pole piece portion is formed in the stator core on the outer circumferential side of the first magnet insertion hole and the second magnet insertion hole, and a magnetic circuit is formed in which the magnetic flux of the d-axis generated by the first and second permanent magnets passes through the magnetic pole piece portion and the stator core and intersects the stator windings.

12. The electric rotating machine according to claim 8,
wherein an auxiliary magnetic pole is formed between the magnetic poles adjacent to each other, and a bridge portion connecting the magnetic pole piece portion with the auxiliary magnetic pole portion adjacent thereto is formed on the outer circumferential side of the magnetic air gap, the bridge portion reducing leakage magnetic flux from the magnetic piece portion to the auxiliary magnetic pole.

13. An electric vehicle including the electric rotating machine according to claim 1, comprising:
a control circuit for controlling the electric rotating machine;
wherein the control circuit operates the first and second permanent magnets within a range of reversible demagnetization.

14. The electric vehicle according to claim 13,
wherein in a first operating range where rotational speed of the electric rotating machine is higher than a predetermined rotational speed, the control circuit controls an AC current to be supplied to the stator windings so as to generate magnetic flux in a direction of reducing magnetic flux of a d-axis generated by the permanent magnets, and the magnetic flux generated by the stator windings acts as magnetic flux with a polarity opposite to that of the second permanent magnet forming the magnetic pole of the rotor.
